(19) United States
(12) Patent Application Publication
(10) Pub. No.: US 2008/0208956 A1
(43) Pub. Date: Aug. 28, 2008

(54) CONTENT AGGREGATION AND SHARING SYSTEM

(76) Inventors: Gregg N. Spiridellis, Santa Monica, CA (US); Evan N. Spiridellis, Santa Monica, CA (US)

Correspondence Address: MCDERMOTT WILL & EMERY LLP, 2049 CENTURY PARK EAST, 38th Floor, LOS ANGELES, CA, 90067-3208, US

(21) Appl. No.: 11/611,068

(22) Filed: Dec. 14, 2006

Related U.S. Application Data
(60) Provisional application No. 60/597,635, filed on Dec. 14, 2005.

(51) Int. Cl. G06F 15/16

(52) U.S. Cl. 709/203

(57) ABSTRACT

A system for the aggregation and sharing of entertainment content on a global communications network, such as the Internet. A hosted service provides at least one server, one database, and software operating the server and the database to provide a web site on the network. The web site permits users to each set-up one or more accounts in accord with a JokeBox metaphor for storing instances of the entertainment content in the database. At least some of the users send emails to the hosted service containing entertainment content for inclusion in their accounts, with the hosted service permitting them to specify classes of the users which can view the entertainment content in their said accounts. The hosted service then presents the entertainment content in the accounts at the web site, thus aggregating and sharing the entertainment content.

### CROSS-REFERENCE TO RELATED APPLICATIONS

This application claims the benefit of U.S. Provisional Application No. 60/597,635, filed 14 Dec. 2005, hereby incorporated by reference in its entirety.

### TECHNICAL FIELD

The present invention relates generally to communications within global communications networks, and more particularly to facilitating the distribution of entertainment between users of a socially networked community.

### BACKGROUND

Comedic content distributed by email is the most prevalent format of entertainment on the Internet and, until now, there has not existed a system to aggregate that content. In the past, people have always had to wait until the latest email arrived in their inbox to enjoy it. What is sorely needed is an application that provides a place for people to go, to use a pull versus push approach, to find the jokes in circulation that best fit that individual's sense of humor and to provides tools that enable that individual to share that humor content with like minded friends. For the sake of discussion, we can term this a “JokeBox application.”

The desired JokeBox application should preferably aggregate email jokes (text, photos, videos, etc.; collectively “content”) in a socially networked community. It can provide services allowing users to store and organize their favorite email content in one place, to share instances of it with friends, and to discover other funny content in emails submitted by other users.

### DISCLOSURE OF INVENTION

Accordingly, it is an object of the present invention to provide a system for the aggregation and sharing of entertainment content.

Briefly, one preferred embodiment of the present invention is a system for the aggregation and sharing of entertainment content on a global communications network, such as the Internet. A hosted service is provided that has at least one server, one database and software operating the server and database to provide a web site on the network. The web site then permits the users to each set-up one or more accounts in accord with a JokeBox metaphor for them to store instances of the entertainment content in the database. At least some of the users send emails to the hosted service containing entertainment content for inclusion in their accounts, with the hosted service permitting the users to specify classes of users which can view the entertainment content in their respective accounts. The hosted service then presents the entertainment content in the accounts at said web site, thus aggregating and sharing the entertainment content.

Briefly, another preferred embodiment of the present invention is a method for hosting a service to aggregate and share entertainment content on a global communications network, such as the Internet. Accounts are provided in accord with a JokeBox metaphor, for users to store instances of the entertainment content. Emails from at least some of the users are received containing entertainment content for storage in the accounts. And the entertainment content in the accounts is presented at a web site, thus aggregating and sharing the entertainment content.

And briefly, another preferred embodiment of the present invention is a method for a user to share entertainment content on a global communications network with other users, such as the Internet. An email containing at least one instance of the entertainment content is sent to a hosted service having accounts in accord with a JokeBox metaphor. The hosted service stores the instances of the entertainment content for presentation of such instances in the accounts at a web site. And a class identifying which of the users can view the entertainment content at the web site is assigned assigned.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figures of drawings in which:

FIG. 1 is a block diagram depicting how an embodiment of a JokeBox application that is in accord with the present invention.

FIG. 2 is a flow chart summarizing an exemplary JokeBox process usable by the JokeBox application.

FIG. 3 is a screen capture depicting an example of a display web page.

FIG. 4 is a screen capture depicting an example of a configuration page.

FIG. 5 is a screen capture depicting an example of an edit web page.

And FIG. 6 is a screen capture depicting an example of a JokeBox page.

In the various figures of the drawings, like references are used to denote like or similar elements or steps.

### BEST MODE FOR CARRYING OUT THE INVENTION

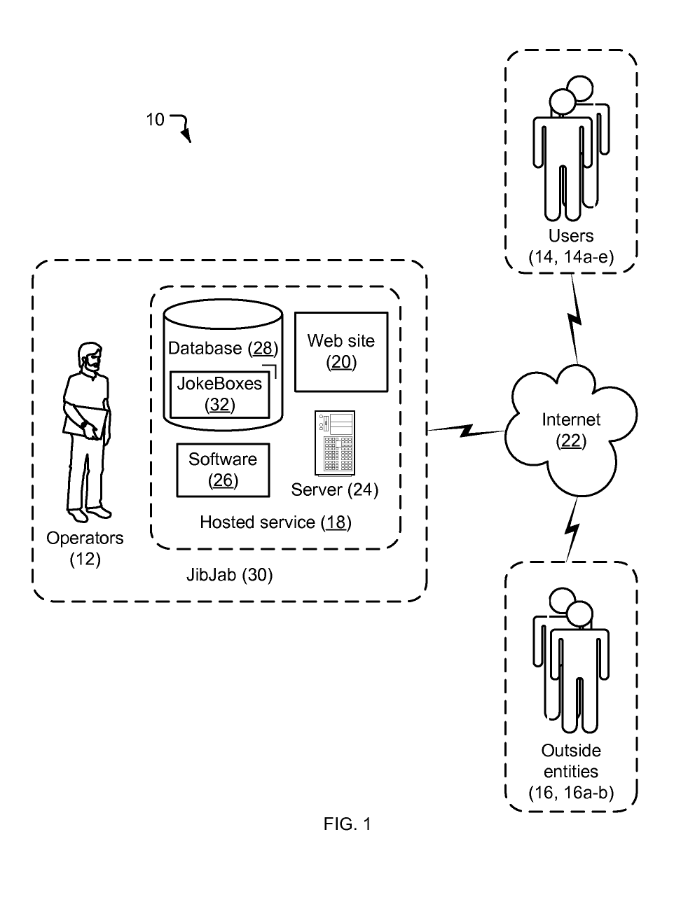

A preferred embodiment of the present invention is a system for the aggregation and sharing of comedic content. As illustrated in the various drawings herein, and particularly in the view of FIG. 1, preferred embodiments of the invention are depicted by the general reference character 10.

FIG. 1 is a block diagram depicting how an embodiment of a JokeBox application 10 that is in accord with the present invention. The parties working with the JokeBox application 10 include operators 12, users 14, and outside entities 16.

Generally, the JokeBox application 10 operates as a hosted service 18 that is made available at a web site 20 on the Internet 22. For example, the hosted service 18 can be implemented with as little as one conventional server 24 with suitably programmed software 26 and a database 28. Of course, multiple servers 24, each with appropriate software 26 for their respective tasks, can also be employed. Similarly, multiple databases 28 can be employed.

The present inventors operate JibJab Media Inc., of Santa Monica, Calif., which is currently providing one embodiment of the inventive JokeBox application 10 at its web site 20 (www.JibJab.com) on the Internet 22. Collectively, the operators 12 and the hosted service 18, with all of its elements, are herein termed JibJab 30 and are used as an exemplary embodiment of the present invention in the following discussion

The users 14 of the JokeBox application 10 principally perceive it as the web site 20 with a collection of JokeBoxes 32. Each user 14 is provided at least one JokeBox 32 (which is effectively space in the database 28). After a new user 14 sets up an account, the process to populate their JokeBox 32 is simple. When they receive a funny email from a friend in their normal email application (e.g., Outlook™), the user 14 simply forwards the email to JibJab 30 (e.g., to jokes@JibJab.com). JibJab 30 then matches the “from” email address with the account of the user 14 and, after validation by the user 14, publishes the content in his or her JokeBox 32.

At the web site 20, the users 14 are able to surf each other's JokeBoxes 32 in search of funny content. If they see a joke they like, they can click a button to add it to their personal JokeBox 32. If a user 14 finds another user 14 who always posts funny jokes, the first user 14 (a fan user 14a) can configure their account to become a fan of the other user 14 (an idol user 14b) and get notified anytime the idol user 14b posts new content. The users 14 can also send private messages to the other users 14 and, generally, build social relationships with each other.

The Internet 22 is today widely thought of as being impersonal and even anonymous, and many feel our entire society is tending this way. Yet Internet-based services that employ basic social principles can be remarkable exceptions to this.

Humor is well known as one way past social barriers, and the JokeBox application 10 actually counter leverages the socially distancing aspect of the Internet 22. For example, even humor has traditionally been limited to some extent by where we get the opportunity to share it. A minor clerk might tell a joke to the president of a large company over the office water cooler, or an investment counselor and a dock worker accompanying their spouses to a holiday party might get a chance to recount funny experiences. Within our currently existing general social structure, however, the inherent degrees of separation and the limitations to our respective social circles make it unlikely that the writer of these words and most readers of them will have an opportunity to exchange humor. Furthermore, again taking social norms into consideration, even if we were to meet face to face, would we then have the ability to determine if we have similar tastes in humor? Would our apparent ethnicity or social status, or our genders or demeanors, lead either of us to presume that we might have a common bond in our preferences in humor? The JokeBox application 10 therefore counter leverages the socially distancing aspects of the Internet 22. It permits like minds, as well as idolizers of witty minds and those seeking respect for their wit, to all connect without the ill easy that often permeates other social interactions.

As the users 14 aggregate jokes in their JokeBoxes 32, the database 28 becomes populated with information and JibJab 30 can develop keen insight into the content and comedic sensibility of the users 14. For example, JibJab 30 can employ collaborative filtering technology to build a detailed understanding of the psychographic profiles of the users 14, based on rich demographic data collected from them during registration and based on their demonstrated senses of humor. The psychographic profiles can then be useful to all of the operators 12, the users 14, and the outside entities 16. The ways such profiles are employed can be transparent to the users 14 via a privacy policy posted on the web site 20.

JibJab 30 can offer multiple levels of access to the users 14. One business model is to sell advertising, on the web site 20 generally as well as tied specifically to the JokeBoxes 32, thus permitting the JokeBox application 10 to be offered for free to free users 14c.

Another model is to sell advertising-free access to paid users 14d. This access can be totally advertising-free, or only partially so. For instance, the paid users 14d might be spared “click-to-continue-to-the-content” type advertising. Or they might be spared all advertising but that provided in a small web page sidebar. Or they might encounter advertising at the web site 20 initially, but then be spared it once they access their JokeBoxes 32. The paid users 14d might also be provided with search, filtering, cataloging, and other tools that permit them to more efficiently use the JokeBoxes 32.

Another business model is to provide limited free access and sell access to high-volume users 14e. Many variations of this are possible. For instance, JibJab 30 can charge the high-volume users 14e for JokeBoxes 32 with capacities beyond a set limit. Without limitation to these few cases, the capacity can be megabyte/gigabyte-storage-footprint based, or megabyte/gigabyte-download-per-unit-time based, or format-of-content based (e.g., providing text for free but charging for audio or video).

The users 14 also benefit from the psychographic profiles. For example, JibJab 30 can use these to refer users 14 to content and other users 14, based on the overt and practiced preferences of the users 14. The practices of the users 14 can also guide JibJab 30 in assigning content to sub-genres, which can then be recommended to users 14 who would appear to like specific sub-genres. And JibJab 30 can provide “others that have liked this content/source also liked . . . ” type links.

The outside entities 16 are simply parties that have an interest in the JokeBox application 10 other than the operators 12 and the users 14. For example, two sub-classes here include advertisers 16a and researchers 16b. The psychographic profiles of the users 14 are potentially very valuable to the outside entities 16.

Based on the psychographic profiles, advertising can be tailored to the users 14 collectively, or to targeted subsets of them. In particular, since the users 14 are tied to their own JokeBoxes 32, and optionally may be associated with other JokeBoxes 32, it is easy to tie specific advertising to the JokeBoxes 32. Thus, the advertisers 16a can buy access to very highly targeted market segments of the users 14. Furthermore, since the web site 20 of JibJab 30 uses a pull delivery methodology, conventional tools can be used to measure the success of such advertising.

The researchers 16b using the JokeBox application 10 potentially includes many groups. Obviously, the advertisers 16a can also be researchers 16b, using the JokeBox application 10 to study how to improve their services. Another group of researchers 16b that can use the JokeBox application 10 are providers of comedic content, both on and off of the Internet 22. Traditionally, producers of comedic content have had very few metrics available to them to analyze the success of their product. The JokeBox application 10 therefore has great potential to provide information on how well a particular comedic approach is working, based on the patterns of how members of the audience (users 14) share the content (and which demographic and psychographic clusters respond best to it). This information could also be used by such content producers to improve their work product, and even for schools to use in better training the next generations of content creators.

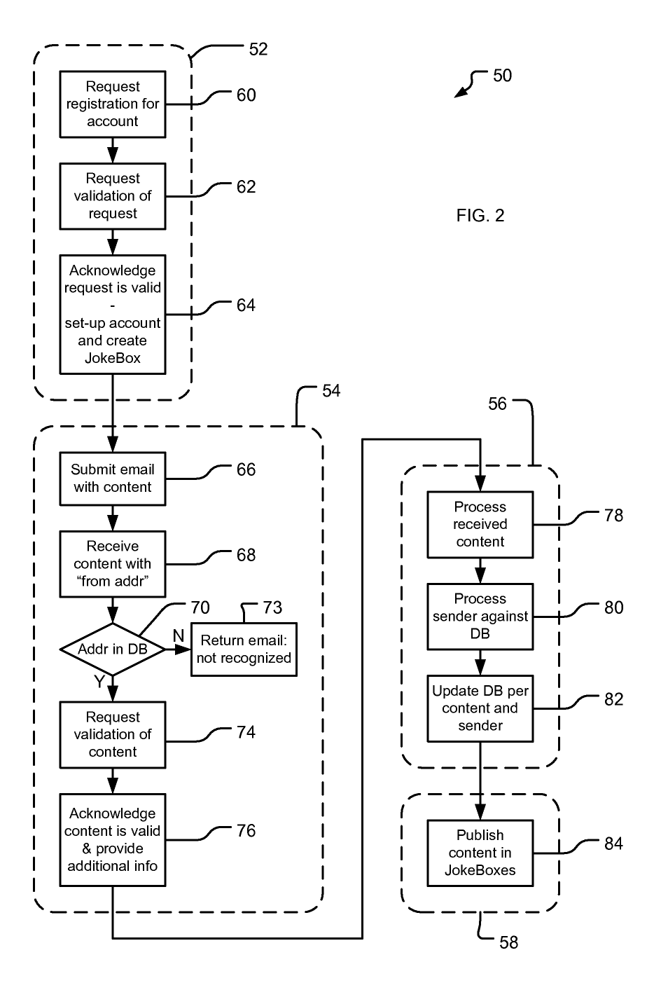

FIG. 2 is a flow chart summarizing an exemplary JokeBox process 50 usable by the JokeBox application 10. The JokeBox process 50 includes four major stages: stage 52, for account establishment; stage 54, for content addition to the account; stage 56, for content processing; and stage 58, for content publishing.

In stage 52, a user 14 establishes an account with JibJab 30. In a step 60, a visitor at JibJab 30 (e.g., at www.JibJab.com) registers to set up a JokeBox 32. As part of this the potential user 14 provides his or her email address(es).

In a step 62, an email is sent to the user 14 to “validate” that he or she is the owner of that email address and that they intended to sign up for an account.

In a step 64, the user 14 acknowledges their intention to establish an account (e.g., clicks a link in the email), and JibJab 30 sets up an account and creates a JokeBox 32 for the user 14.

In stage 54, in the future after stage 52, content is added to the account. In a step 66, the user 14 receives a humorous email (e.g., a joke) from a friend in his or her standard email account software (e.g., Outlook™, Hotmail™, etc.), they can then save this in their JokeBox 32 at JibJab 30 by simply forwarding the email to a designated email address (e.g., Jokes@JibJab.com, with originating email address information used to see the forwarded email goes into the right JokeBox 32). Content can also be uploaded or entered directly into the account using tools at the JokeBox website.

In a step 68, JibJab 30 receives the incoming email and looks at the “from” address.

In a step 70, if the address exists in the database 28 as that of a registered user 14, the content is accepted into a queue for validation. Alternately, in a step 72, if the email address does not exist in the database 28, an auto message is returned to the “from” email address advising that the email address was not recognized and inviting the recipient to sign up for an account (or to update their account information, say, if an existing user 14 is employing a new email address).

Before the joke or other comedic content is published on the web site 20 (or accepted into their JokeBox 32), the user 14 must validate that he or she sent the joke and designate the “sharing status” for the content.

Accordingly, in a step 74, JibJab 30 sends the user 14 a validation link in an email (in one embodiment of the invention; alternately, designated email addresses can be set-up on a per user 14 basis, thus accommodating users 14 who may want to make submissions from many email addresses, potentially including ones that are in determinant at initial registration), to verify that the user 14 indeed sent the content (and not somebody else spoofing their address).

And in a step 76, when the user 14 clicks the validation link (or responds in a similar manner in other embodiments of the invention) they are taken to a web page at JibJab 30 where they can provide additional information about the content and designate a “share status” for it. The information collected from the user 14 on this page can include: the title of the content, a brief description about the content, and a sharing status such as “public,” “friends,” or “private.” After the user 14 provides this information, the content is “processed” for entry into their JokeBox 32.

In stage 56, after stage 54 and content entry, the now validated content is processed before it is published. In a step 78, the content is first “scrubbed” for the best possible presentation to end users. If the content is text (i.e., a joke), all of the miscellaneous characters that are inserted from forwarding emails (e.g., <<<<, re:, fwd:, etc.) are removed. If the content is audio or video, it can also be processed as desired, say, to convert it from its source format into another format. For example, a video in AVI format may be converted into a “Flash” movie so that it can be played within a stylized player at the web site 20 of JibJab 30.

In a step 80, the name and email address of the person who sent the joke to the user 14 is stripped from the original email. If that person is not already in a “Friends” list for the user 14, the person can be added. An entry is also made in the database 28 that associates this friend with the content, so that in the future, the user 14 can sort content by who sent it to him or her. For example, a user 14 may want to see all the jokes their dad has sent to them over the years. By tagging a joke with the original sender's name, the JokeBox application 10 can automatically keeps track of such information. This information can be held as private and then only be viewable and accessible by the user 14 owning the account.

Considerably more can be done here. With the text of the content, and with the text that the submitting user 14 provides in their title and description of it, the content can be tagged, cataloged, cross-referenced, key-word searched, etc. Before the content is published, automated software can be used to determine if other instances of the content exist in the database 28, and associated then. This reduces storage costs and permits optimizing an ability to cluster the users 14 based on what they have in their JokeBoxes 32. For example, with video the MD5 code enables the identification of unique instances of the video. For text jokes, search-engine-like algorithms can be used to define thresholds (e.g., if they are 97% the same, and then group them together). And all of this can then be used to assist the users 14 to broaden their social interactions with each other.

In a step 82, all of the information for the content (and sender) is stored in the database 28, associated with the account of the user 14.

In stage 58, after stage 56 and content processing, the content is published. In a step 84, the content appears in the JokeBox 32 of the user 14.

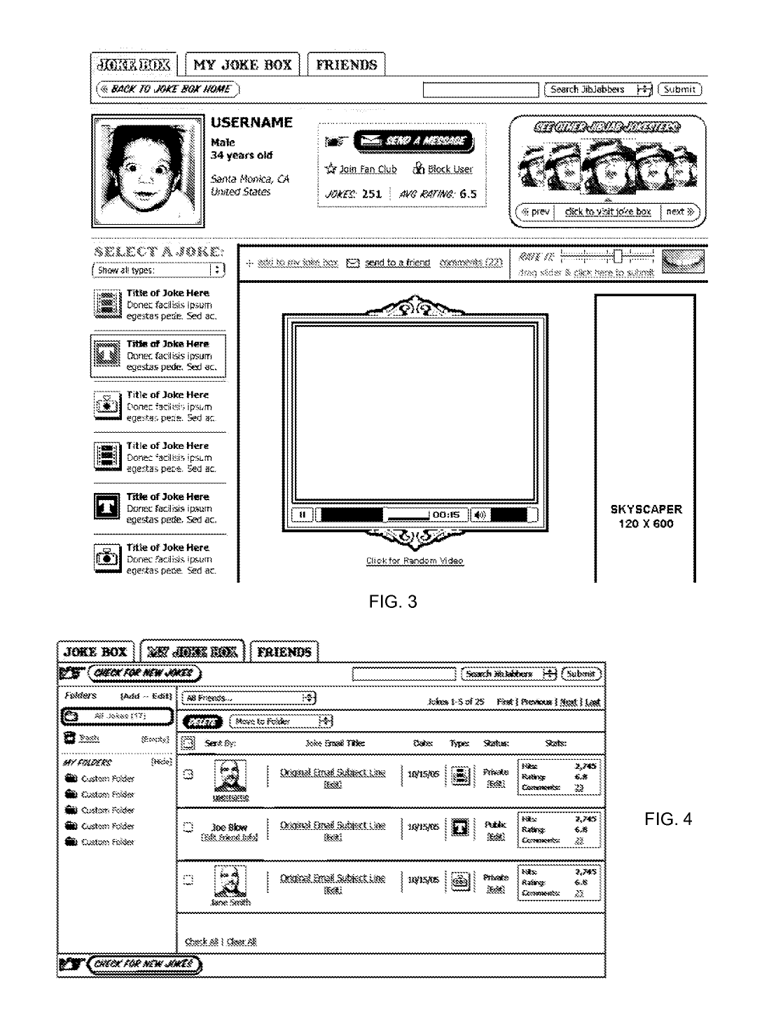

If a user 14 designated their sharing as “public,” any visitors to JibJab 30 can now see it. FIG. 3 is a screen capture depicting an example of a display web page. Here a video submitted by the user 14 appears in the public section of their JokeBox 32. Alternately, if the providing user 14 designated the content as “friends,” it would only appear in the JokeBoxes 32 of other users 14 that are on the “friends” list of the providing user 14. And if the joke is designated “private,” it would only appear to the user 14 himself or herself.

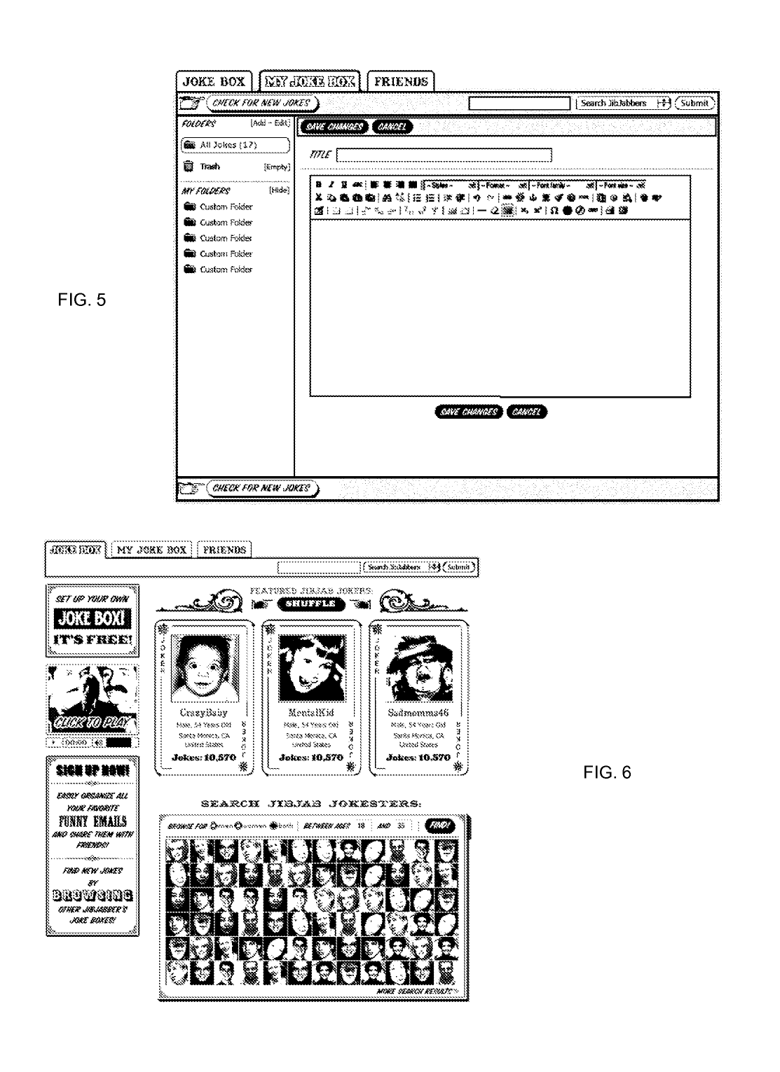

Optionally, the users 14 can log into their accounts and manage their content from an interface very similar to a web-based email program. FIG. 4 is a screen capture depicting an example of a configuration page. The users 14 can here also see current statistics such as “hits,” “ratings,” and “comments” by other users 14. FIG. 5 is a screen capture depicting an example of an edit web page. If a user 14 wants, they can go in here and edit their content with an html editor (for example, if they want to change the text or format).

One of the primary differentiating factors over other clips/humor sites is that the inventive JokeBox application 10 is organized around the users 14 (as opposed to the editorial discretion of the operators 12). This permits the JokeBox application 10 to provide a rich variety of community features and to be a part of a wide ranging social networking fabric.

FIG. 6 is a screen capture depicting an example of a JokeBox page. Here it can particularly be seen that the inventive JokeBox application 10 can provide user-centric navigation and a community experience based on the individual and collective actions of the users 14 in the social network that JibJab 30 provides. Accordingly, search functionality will exist to allow people to discover and connect with other “people” in the network in addition to the search functionality that will enable users 14 to discover “content”.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A system for the aggregation and sharing of entertainment content on a global communications network, such as the Internet, the system comprising:
a hosted service having at least one server and one database and server software operating said server and database software operating said database to provide a web site on the network; and
said web site permitting users to each set-up one or more accounts in accord with a JokeBox metaphor for storing instances of the entertainment content in said database, wherein at least some of said users send emails to said hosted service containing the entertainment content for inclusion in their said accounts, wherein said hosted service permits said users to specify classes of which said users can view the entertainment content in their said accounts, and wherein said hosted service presents the entertainment content in said accounts at said web site, thereby aggregating and sharing the entertainment content.

2. The system of claim 1, wherein:
said hosted service further includes profiling software to build psychographic profiles of said users.

3. The system of claim 2, wherein:
said profiling software builds said psychographic profiles of said users based on at least one member of the set consisting of overt user preferences as reflected in data submitted by said users, observed user preferences as reflected in the entertainment content provided by said users, observed user preferences as reflected in handling of the entertainment content once provided by said users, observed user preferences as reflected in said users viewing of the entertainment content provided by other said users, and observed user preferences as reflected in said users handling of the entertainment content provided by other said users.

4. The system of claim 2, wherein:
said hosted service further presents advertising in association with presenting the entertainment content in said accounts at said web site, wherein said advertising is tailored based on said psychographic profiles.

5. The system of claim 1, wherein:
said hosted service further presents advertising in association with presenting the entertainment content in said accounts at said web site.

6. The system of claim 1, wherein:
said hosted service further verifies which said user a said email comes from.

7. The system of claim 1, wherein:
said hosted service further processes the entertainment content in said emails astatically to enhance its presentation at said web site.

8. The system of claim 1, wherein:
said hosted service further converts format of the entertainment content in said emails to standardize its presentation at said web site.

9. The system of claim 1, wherein:
said classes include at least two members of the set consisting of a said user who provided the entertainment content, other said users specifically identified by a said user who provided the entertainment content, and all said users of the system.

10. The system of claim 1, wherein:
said web site further permits said users to exchange access to and discourse on the entertainment content, thereby providing said users with a social networking environment.

11. A method for hosting a service to aggregate and share entertainment content on a global communications network, such as the Internet, the method comprising:
(a) providing accounts in accord with a JokeBox metaphor for users to store instances of the entertainment content;
(b) receiving emails from at least some of said users containing the entertainment content for storage in their said accounts; and
(c) presenting the entertainment content in said accounts at a web site, thereby aggregating and sharing the entertainment content.

12. The method of claim 11, wherein:
said (b) includes verifying which said user a said email comes from.

13. The method of claim 11, wherein:
said (b) includes accepting from said users classes specifying which said users can view the entertainment content in their said accounts.

14. The method of claim 13, wherein:
said classes include at least two members of the set consisting of a user who provided the entertainment content, other said users specifically identified by a user who provided the entertainment content, and all said users of the system.

15. The method of claim 11, wherein:
said (c) includes presenting advertising in association with said presenting the entertainment content in said accounts at said web site.

16. The method of claim 11, further comprising:
(d) building psychographic profiles of said users based on at least one member of the set consisting of overt user preferences as reflected in data submitted by said users, observed user preferences as reflected in the entertainment content provided by said users, observed user preferences as reflected in handling of the entertainment content once provided by said users, observed user preferences as reflected in said users viewing of the entertainment content provided by other said users, and observed user preferences as reflected in said users handling of the entertainment content provided by other said users.

17. The method of claim 16, wherein:
said (c) includes presenting advertising in association with said presenting the entertainment content in said accounts at said web site, wherein said advertising is tailored based on said psychographic profiles.

18. The method of claim 11, further comprising:
prior to said (c), processing the entertainment content astatically to enhance its presentation at said web site.

19. The method of claim 11, further comprising:
prior to said (c), converting format of the entertainment content for presentation at said web site.

20. A method for a user to share entertainment content on a global communications network with other users, such as the Internet, the method comprising:
sending an email containing at least one instance of the entertainment content to a hosted service having accounts in accord with a JokeBox metaphor, wherein said hosted service stores said instances of the entertainment content and presents said instances of the entertainment content in said accounts at a web site; and
assigning the entertainment content from said email to a class identifying which of the users can view the entertainment content at said web site.
